(19) United States
(12) Patent Application Publication
(10) Pub. No.: US 2005/0223915 A1
(43) Pub. Date: Oct. 13, 2005

(54) Press for processing any type of material

(76) Inventors: August Van Der Beek, Grevenbroich (DE); Reyk Buch, Bonn (DE); Harald Pechtel, Neuss (DE); Andreas Klother, Kaarst (DE)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 10/508,627

(22) PCT Filed: Feb. 18, 2003
(86) PCT No.: PCT/DE03/00490

§ 371 Date: May 13, 2005

(30) Foreign Application Priority Data
Mar. 21, 2002 (DE) 102 12 730.1

(51) Int. Cl. B30B 1/00

(52) U.S. Cl. 100/214; 100/215; 100/233; 100/240

(57) ABSTRACT

The invention relates to a press for processing, such as pressing and/or shearing, any type of material (3), particularly scrap metal or metal wastes, comprising: a bed (1) for filling and strand-like compacting and feeding this material (3); a downward-located column (2) having at least one stamper (2.2), which is guided inside the column while being driven by a second hydraulic cylinder (2.2.2) attached to a crosshead (2.1) of the column (2); at least one third hydraulic cylinder (2.4.2), and; a hydraulic control (5) provided with a control block (7) and pipes (6). This press should, in order to increase its overall efficiency, improve the feeding/loading of the material (3) to be processed, ensure a largely coordinated execution of the functional steps, optimize the kinematic sequence of the functional elements and the expenditure of energy therefor, have a reduced loading height and bed length, check the state of wear and monitor the operating state both of the kinematic sequences as well as of the hydraulic system while making them visible to the press operator whereby, all in all, increasing the availability of the press, the intensity of the processing of the material (3) and the output quota thereof from the press.

### FIELD OF APPLICATION OF THE INVENTION

The invention relates to a press for processing, such as pressing and/or shearing, any type of material, in particular scrap metal or metal waste.

### PRIOR ART

Such presses are known according to DE A 18 08 136 and have essentially:
a bed for filling with this material and compacting it in a string-like fashion and also feeding it for further processing such as pressing and/or shearing with first hydraulic cylinders for driving the compaction and feed steps;
a downstream column with, guided therein and driven by a second hydraulic cylinder fastened in a crosshead of the column, (at least) one stamper for further compaction and/or holding-down of the material against a table;
at least one third hydraulic cylinder for final processing such as pressing and/or shearing of the material against the table, and
a hydraulic control with control block and pipelines for operating said hydraulic cylinders, means for generating a damping pressure already being previously known, however, according to DE A 44 20 682.

In principle, these presses have proved successful. However, they have thus far been improved only in individual functions, subassemblies and individual parts.

### PRESENTATION OF THE ESSENCE OF THE INVENTION

An overall examination of the improvements thus far reveals no attempts which increase the efficiency of such presses in their technological functions and constructional forms.

The object of the invention is to increase the overall efficiency of presses of the generic type described in the introduction, both the technological flow of the material to be processed and the optimization of the construction being investigated in this problem definition. Accordingly, with the interacting subassemblies of the press,
the feed of the material to be processed is to be improved;
largely coordinated operation of the functional steps is to be ensured;
the kinematic sequence of the functional elements and the driving forces to be set up are to be optimized;
an overall compact construction, such as by reducing the loading height and bed length, is to be achieved;
the state of wear is to be checked, and
the operating state of on the one hand the kinematic sequences of the coordinated working steps and on the other hand the hydraulic system is to be monitored and made visible for the press operator,
   in order for it ultimately to be possible to increase the availability of the press, to intensify the processing of the material and to increase the output quota. Finally, the press is also to be cost-effectively manufacturable and prefabricated in largely compact subassemblies for transport to the installation site and assembly there. A more productive machine which can be used with lower operating costs is consequently provided for the operator of such a press.

According to the invention, this object is achieved by means of the combination of the following features:
a) the bed is composed of a bottom of a wall, a press plate, displaceable on the bottom parallel to the wall, of a lateral slide with a hydraulic cylinder, a press cover, mounted pivotably on the wall, with at least one hydraulic cylinder, a feed plate, displaceable on the bottom transversely to the direction of the press plate, of a slide with the hydraulic cylinder, feet and a filling hopper, the lateral slide with press plate and the press cover shaping in a functionally controlled sequence the cross section of the material compacted in a string-like fashion, and the slide with feed plate supplying the material thus shaped in the form of a feed motion to final processing such as pressing and/or shearing in the column;
b) the column consisting of the crosshead connecting the side parts and of the table being formed as a closed, rigid frame for taking up the reaction forces arising and being designed for connection of the bed;
c) the hydraulic cylinders with pistons have means corresponding to reference points and/or quantities for functionally integrated measurement of the displacement, of the speed, of the acceleration and/or of the pressure of a kinematic state of at least one machine part, one operating state and/or the material for an optimized and temporally coordinated operating sequence and/or processing operation of the material, and
d) means are provided in the hydraulic control, which, at least in one of the hydraulic cylinders at the end of its working stroke, generate a damping pressure as for damping what is known as a cutting shock and/or end shock.
e) A torsion shaft is mounted on or in the bed and, by means of at least one mechanism such as a lever, is connected in an articulated manner to the press plate via a connecting-rod-like link in such a way that the torsion shaft with lever and the link, to prevent canting of the press plate of the lateral slide, exerts a horizontal parallel thrust on the material and at the same time a force component toward the bottom of the bed to prevent the press plate lifting off, and
f) the press cover is designed in such a way that it
f1) has a power arm which can be guided at least in part around the wall and/or the bottom and is connected to the hydraulic cylinder which is preferably articulated below the bottom;
f2) has a press arm acting on the material, which is formed by the press cover itself, the pivoting axis of the press cover running along an upper edge of the wall;
f3) is, with its power arm and hydraulic cylinder and also its press arm, designed in such a way in its particular position and exertion of the compaction acting vertically on the material that the magnitude, introduced with the pivoting movement, of the press arm force bringing about the compaction of the material, starting with the angular position 0° of the press cover, related to the wall, increases as far as the angular position of roughly 40°-60°, the active force after an angular position of roughly 100° has been reached still being greater than the force acting on the material at the beginning of pivoting, and accordingly exerts the force acting on the formation of the string of material in any position>0° of the press cover with a multiple of the force acting at 0° (see diagram according to FIG. 3).

The decisive factor of this combination is that the functions of the individual features support one another and lead to homogeneous overall success in accordance with the problem definition, namely to increase the availability of the press, intensify the processing of the material and increase the output quota.

Advantageously subordinate to this combination according to the invention, the bed is
a) divided subassembly-wise for alternative left or right embodiment, seen in a top view of the bed, with at least one technologically identical subassembly;
b) lined with mutually constructionally identical wearing plates which in their particular plurality correspond to the dimensions of at least one subassembly, and
c) in at least one wearing plate provided with a means for indicating the state of wear.

Further developments of the press can be inferred from the features of claims 3 to 7.

Corresponding functionally and constructionally, when the press is embodied as what is known as a scrap shearing machine,
a) a vertically movable carriage for receiving a cutter is guided in the column, which cutter works against a stationary cutter in the table, said cutters, seen in the feed direction of the material prepressed in the bed in a bar-like fashion, separating the material after the further compaction and/or holding-down of the material by the stamper, and
b) the carriage is guided on each side of the column between both an inner, stationary guide and an outer, adjustable guide.

In order to achieve greater cutting lengths of a scrap shearing machine in what is known as the part stroke of the carriage, that is to say when the carriage is not raised completely, the dimensioning of the stamper in its depth (seen in the feed direction of the material) is in optimized proportion to usual cutting lengths, as a result of which compression of the material prepressed in a string-like fashion is also avoided. The background of this embodiment is that previous depths or widths of the stamper were relatively small and as a result only small feed motions were possible. With the relatively wide stamper design according to the invention, a greater feed motion can be selected. As a result, greater cutting lengths of the material are made possible, and higher outputs are realizable with non-full thrust.

Claims 10 to 12 illustrate further features which optimize the functioning of the press in accordance with the problem definition.

In the press according to the invention, the means for functionally integrated measurement of the displacement, of the speed, of the acceleration and/or of the pressure of a kinematic state can be means which measure
without contact,
absolutely in any position,
optically,
magnetically and/or
by means of sound.

The features according to claims 14 and 15 supplement the press in particular in its embodiment as a scrap shearing machine, the features of claims 16 to 24 advantageously supporting the press in its overall functioning for achieving the object of the invention.

### BRIEF DESCRIPTION OF THE DRAWINGS

In the drawings:

FIG. 1a shows the press in a perspective overall illustration, seen from the location of the processed material to be taken away;

FIG. 1b shows the press in a perspective top view of the region of the material with which the bed is to be charged;

FIG. 2a shows the bed of the press in cross section in open position;

FIG. 2b shows the bed according to FIG. 2a in closed position with a pressed string and prefilled material;

FIG. 3 shows a graphic representation of the forces (new) of the press cover acting according to the invention in comparison with the forces (old) acting previously;

FIG. 4a shows a top view of the bed in longitudinal section in what is known as a left embodiment;

FIG. 4b shows a top view of the bed in longitudinal section in what is known as a right embodiment;

FIG. 5a shows a side view of the column in longitudinal section in an embodiment as a scrap shearing machine;

FIG. 5b shows a top view of the column according to FIG. 5a in cross section, and

FIG. 6 shows the control diagram of damping of the cutting shock of the diagrammatically included scrap shearing machine.

### BEST MODE OF EMBODIMENT OF THE INVENTION

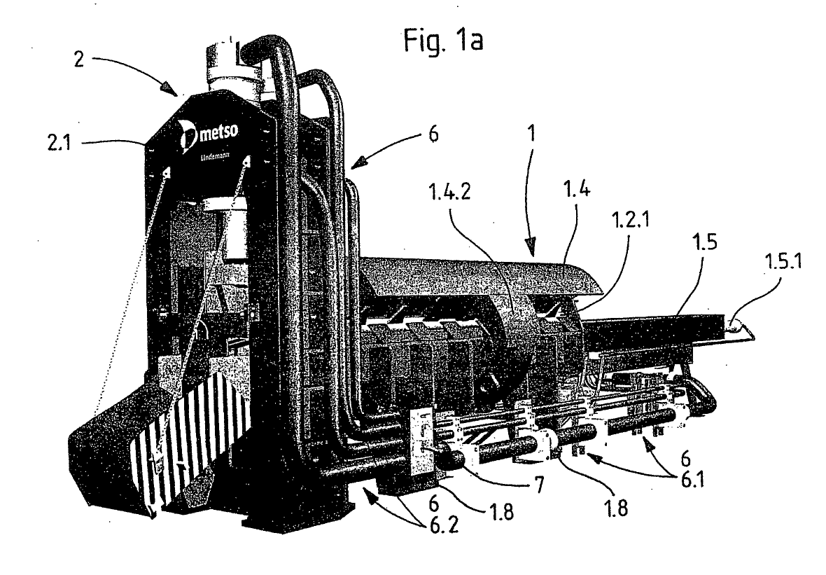

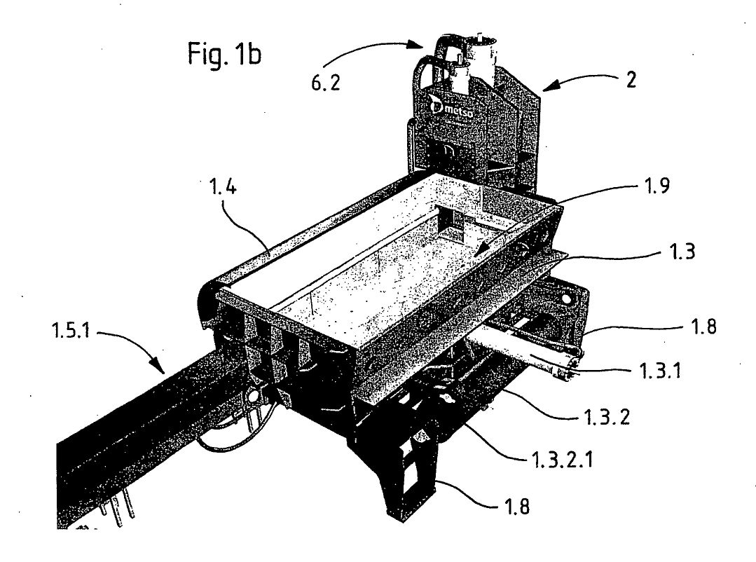

According to FIGS. 1 to 2 and 4 to 5, in its universal function for processing such as pressing and/or shearing any type of material 3, in particular scrap metal or metal waste, the press comprises
a bed 1 for filling with this material 3 and compacting it in a string-like fashion and also feeding it for further processing such as pressing and/or shearing with first hydraulic cylinders 1.3.1, 1.4.1, 1.5.1 for driving the compaction and feed steps;
a downstream column 2 with, guided therein and driven by a second hydraulic cylinder 2.2.2 fastened in a crosshead 2.1 of the column 2, (at least) one stamper 2.2 for further compaction and/or holding-down of the material 3 against a table 2.5;
at least one third hydraulic cylinder 2.4.2 for final processing such as pressing or shearing of the material 3 against the table 2.5, and
a hydraulic control 5 with control block 7 and pipelines 6 for operating the hydraulic cylinders 1.3.1, 1.4.1, 1.5.1, 2.2.2, 2.4.2.

In order to increase its overall efficiency, the press according to the invention is designed in such a way that it
improves the feed/loading of the material 3 to be processed;
ensures largely coordinated operation of the functional steps;
optimizes the kinematic sequence of the functional elements and the expenditure of force for this;
has a reduced loading height and bed length;
checks the state of wear, and
monitors the operating state both of the kinematic sequences and of the hydraulic system and makes it visible for the press operator.

Overall, on the one hand the availability of the press and on the other hand the intensity of processing of the material 3 and its output quota from the press are consequently increased.

In order to achieve this, the bed 1 is according to the invention composed of a bottom 1.1 of a wall 1.2, a press plate 1.3, displaceable on the bottom 1.1 parallel to the wall 1.2, of a lateral slide with the hydraulic cylinder 1.3.1, a press cover 1.4, mounted pivotably on the wall 1.2, with at least one hydraulic cylinder 1.4.1, a feed plate 1.5, displaceable on the bottom 1.1 transversely to the direction of the press plate 1.3, of a slide with the hydraulic cylinder 1.5.1, feet 1.8 and a filling hopper 1.9. In a functionally controlled sequence, the lateral slide with press plate 1.3 and the press cover 1.4 shape the cross section of the material 3 compacted in a string-like fashion. The slide with feed plate 1.5 supplies the material 3 thus shaped in the form of a feed motion to final processing such as pressing and/or shearing in the column 2.

Furthermore, the column 2, which is functionally interrelated with the bed 1 and consists of the crosshead 2.1 connecting the side parts 2.3 and of the table 2.5, is formed as a closed, rigid frame for taking up the reaction forces arising and is designed for connection of the bed 1.

As the driving means of the press, the hydraulic cylinders 1.3.1, 1.4.1, 1.5.1, 2.2.2, 2.4.2 with pistons have means 4 corresponding to reference points and/or quantities for functionally integrated measurement of the displacement, of the speed, of the acceleration and/or of the pressure of a kinematic state of at least one machine part, one operating state and/or the material 3 for an optimized and temporally coordinated operating sequence of the press and/or for the processing operation of the material 3.

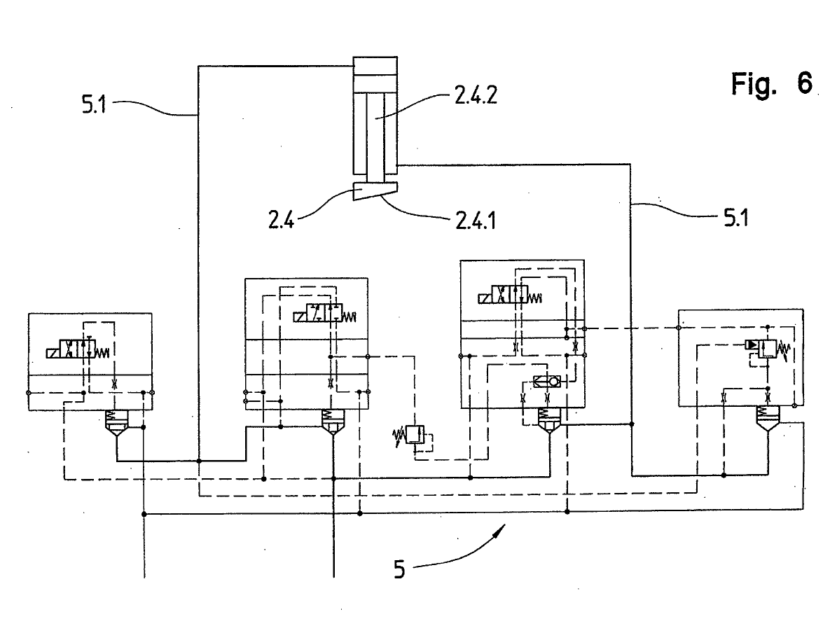

According to FIG. 6, means 5.1 are provided in the hydraulic control 5 of the press, which, at least in one of the hydraulic cylinders 1.3.1, 1.4.1, 1.5.1, 2.2.2, 2.4.2 at the end of its working stroke, generate a damping pressure as for damping what is known as a cutting shock and/or end shock, cutting shock damping supporting the sequences for optimized and temporally coordinated operation of the press and not only favoring the statics of the press.

Additionally, and functionally supporting the features mentioned above, a torsion shaft 1.3.2 is mounted on or in the bed 1 and, by means of at least one mechanism such as a lever 1.3.2.1, is connected in an articulated manner to the press plate 1.3 via a connecting-rod-like link 1.3.2.3 in such a way that the torsion shaft 1.3.2 with lever 1.3.2.1 and the link 1.3.2.3, to prevent canting of the press plate 1.3 of the lateral slide, exerts a horizontal parallel thrust on the material 3 and at the same time a force component toward the bottom 1.1 of the bed 1 to prevent the press plate 1.3 lifting off.

Finally, as a further feature of the press, the press cover 1.4 has a power arm 1.4.2 which can be guided at least in part around the wall 1.2 and/or the bottom 1.1 and is connected to the hydraulic cylinder 1.4.1 which is preferably articulated below the bottom 1.1.

In this connection, a press arm 1.4.3, which is formed by the press cover 1.4 itself, acts on the material 3. The pivoting axis 1.2.1 of the press cover 1.4 runs along an upper edge of the wall 1.2.

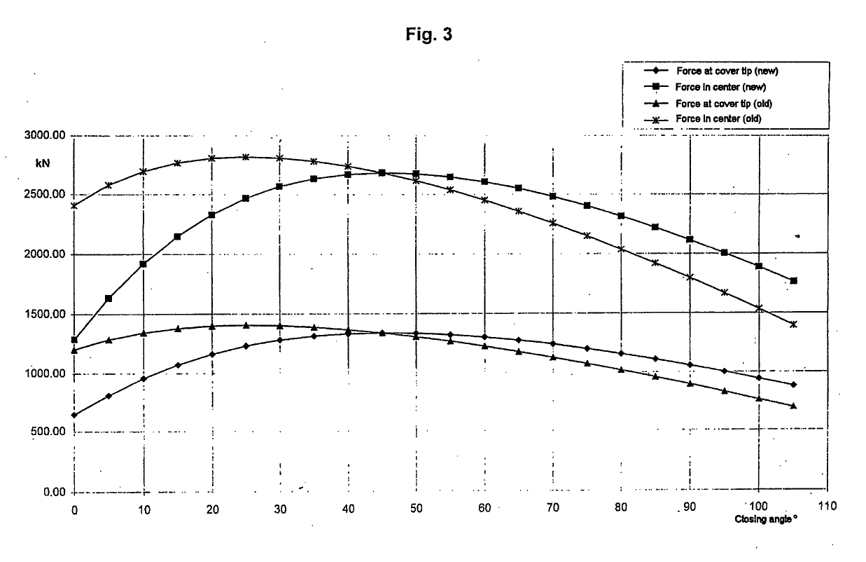

With its power arm 1.4.2 and the hydraulic cylinder 1.4.1 and also its press arm 1.4.3, the press cover 1.4 is designed in such a way in its particular position and exertion of the compaction acting vertically on the material 3 that the magnitude, introduced with the pivoting movement, of the press arm 1.4.3 force bringing about the compaction of the material 3, starting with the angular position 0° of the press cover 1.4, related to the wall 1.2, increases as far as the angular position of roughly 40°-60°, the active force after an angular position of roughly 100° has been reached still being greater than the force acting on the material 3 at the beginning of pivoting. This action is illustrated in FIG. 3 in a graphic comparison with the previous state of the art.

Accordingly, the force acting on the formation of the string of material 3 in any position>0° of the press cover 1.4 is a multiple of the force acting at 0°.

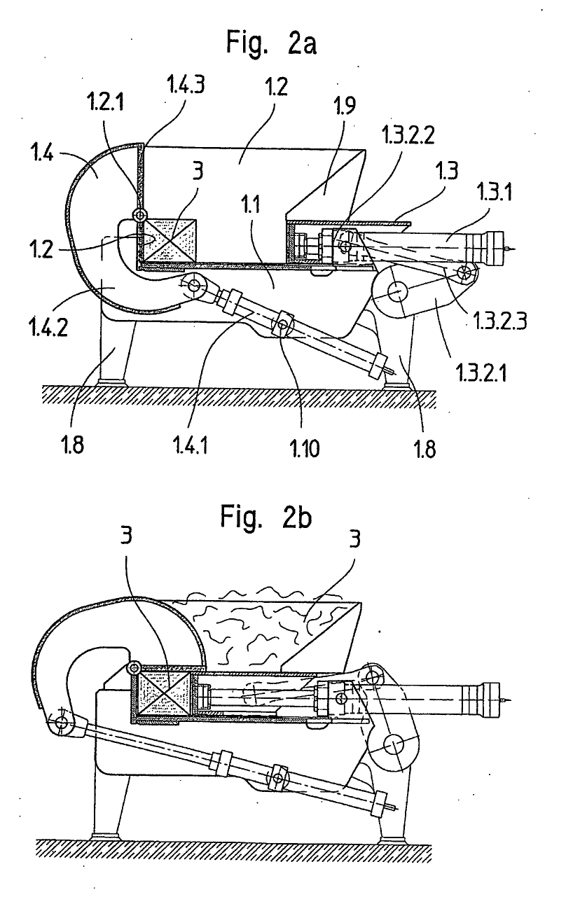

When the press cover 1.4 is fully open according to FIG. 2a, it is located in a self-stabilizing end position owing to its mass.

In order to achieve a closed force flow, the at least one hydraulic cylinder 1.3.1 for the lateral slide 1.3 and the at least one hydraulic cylinder 1.4.1 for the press cover 1.4 are integrated spatially into the profile of the bed 1. The cross-sectional profile of the bed 1 is to this end of ␣-shaped design, and the hydraulic cylinders 1.3.1, 1.4.1 lie in a plane.

Advantageously, the hydraulic cylinder 1.3.1 for the lateral slide 1.3 is supported in a bearing 1.3.2.2 on/in the bed 1, and the hydraulic cylinder 1.4.1 for the press cover 1.4 is articulated in a bearing 1.10 on/in the bed 1.

In a technologically favourable way, the filling hopper 1.9 is arranged as a constructional unit above the bed 1 and can then, in the open position of the bed 1 according to FIG. 2a, receive the entire batch of the material 3 to be processed and, in the closed position of the bed 1 according to FIG. 2b, hold prefilled material 3 ready for the subsequent position as at least a part batch of the material 3 to be processed.

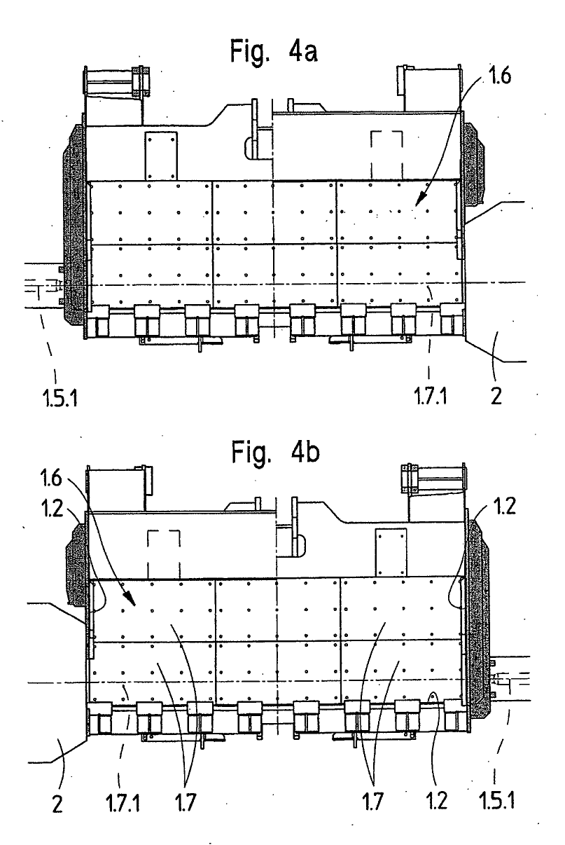

The bed 1 is divided in its subassemblies according to FIGS. 4a and 4b for alternative left or right embodiment with at least one technologically identical subassembly 1.6.

To this end, it is lined with mutually constructionally identical wearing plates 1.7 which in their particular plurality correspond to the dimensions of at least one subassembly 1.6.

At least one wearing plate 1.7 has a means 1.7.1 for indicating the state of wear.

According to the desired sequence of the lateral slide 1.3 and the press cover 1.4, in the advanced position of the lateral slide 1.3 and the pivoted-in position of the press cover 1.4, the material 3 is in the bed 1 precompacted to form a string of approximately rectangular and/or square cross section and prepared for feeding for further processing in the column 2.

Up to here, the description of a press according to the invention applies for the universal use aimed at, that is to say also exclusively as a press without shearing function.

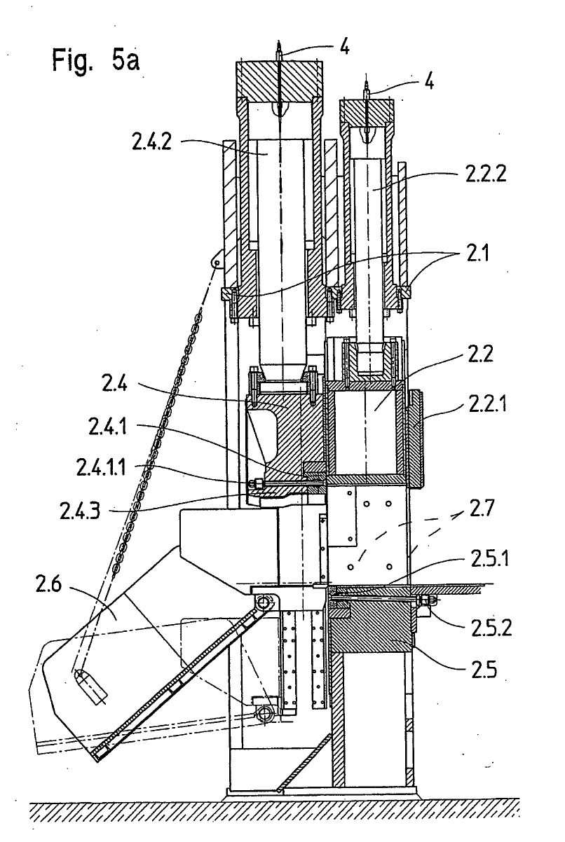

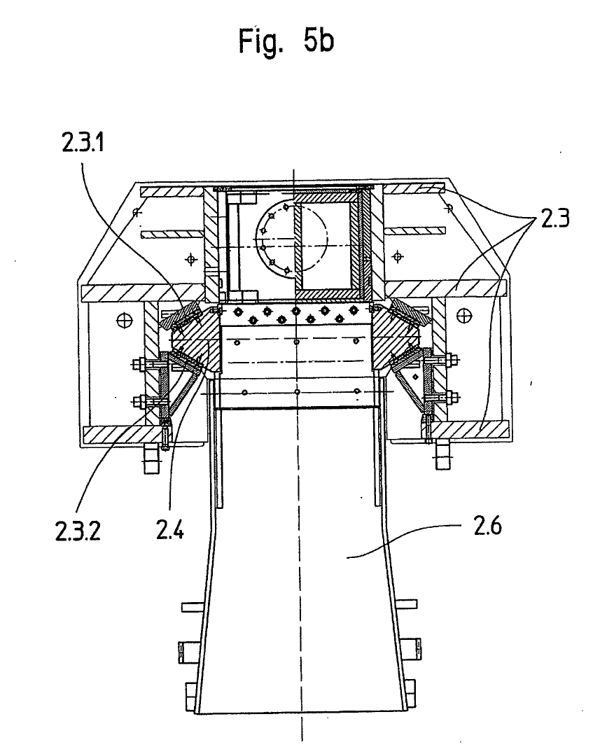

For use as a scrap shearing machine, that is to say a press with a shearing function, a vertically movable carriage 2.4 for receiving a cutter 2.4.1 is guided in the column 2 according to FIGS. 5a and 5b, which cutter works against a stationary cutter 2.5.1 in the table 2.5, said cutters 2.4.1, 2.5.1, seen in the feed direction of the material 3 prepressed in the bed 1 in a string-like fashion, separating the material after the further compaction and/or holding-down of the material 3 by the stamper 2.2, and the carriage 2.4 is guided on each side part 2.3 of the column 2 between both an inner, stationary guide 2.3.1 and an outer, adjustable guide 2.3.2.

In order for it to be possible to achieve greater cutting lengths of the scrap shearing machine in what is known as the part stroke of the carriage 2.4, that is to say when the carriage 2.4 is not raised completely, the dimensioning of the stamper 2.2 in its depth (seen in the feed direction of the material 3) is in optimized proportion to usual cutting lengths. Compression of the material 3 prepressed in a string-like fashion is consequently also avoided.

The stamper 2.2 is guided on a cross-member 2.2.1 which counteracts the forces which widen the [symbol] -frame shape of the column 2.

At least one of the hydraulic cylinders 2.2.2, 2.4.2 can be inserted, in a corresponding opening, from above in the crosshead 2.1 of the column 2 and also locked after radial rotation and fastened detachably.

According to another variant, at least one of the hydraulic cylinders 1.3.1, 2.2.2, 2.4.2 can be inserted and fastened detachably, in a corresponding opening, in its respective seat, such as, for example, from below in the crosshead 2.1 of the column 2, the fastening elements being designable in terms of forces in such a way that they have to take up only the forces of the respective hydraulic cylinder 1.3.1, 2.2.2, 2.4.2 in the return stroke.

The functionally integrated means 4 for measurement of the displacement, of the speed, of the acceleration and/or of the pressure can be designed in such a way that they measure
without contact,
absolutely in any position,
optically,
magnetically and/or
by means of sound.

According to FIG. 1a and in particular FIG. 5a, an inclined plane surface designed as a chute 2.6 for gravity-dependent removal of the cut material 3 is arranged downstream of the column 2, which surface can be varied in its inclination depending on the stroke of the hydraulic cylinder 2.4.2 responsible for cutting the material 3.

It is advantageous if the cutters 2.4.1, 2.5.1 are fastened in their respective holders by means of a hydraulic cutter-clamping device 2.4.1.1, 2.5.2 according to FIG. 5a in order to avoid play between the cutters 2.4.1, 2.5.1 and their holders.

In order to derive optimized operating sequences, it is possible to detect values via means such as sensors 2.7 (FIG. 5a) from properties of the material 3 as a reference variable for the press.

It can be seen from FIG. 5a that the stamper 2.2 can be operated coupled to or uncoupled from the carriage 2.4.

Furthermore, according to FIG. 5a, a bending stamp 2.4.3 acting on the material 3 before the cutter 2.4.1 is arranged on the carriage 2.4.

FIG. 1a illustrates that, in order to achieve a high degree of preassembly and for the purpose of transport to the installation site, a preassembled first subassembly 6.1 of pipelines 6 is attached to a pair of the feet 1.8 on the bed 1 and a preassembled second subassembly 6.2 of pipelines 6 is attached to the column 2.

For the operational management of the press, the use of a display indicating the respective operating state of at least one of the functions of the bed 1 and/or of the column 2 is to be recommended. To this end, predefined sub-programs can be installed and optionally combined.

In order for it to be possible to determine the state of wear of the machine on the basis of the pressure ratios, further means (not illustrated) are arranged in exposed locations on the hydraulic cylinders 1.3.1, 1.4.1, 1.5.1, 2.2.2, 2.4.2.

### INDUSTRIAL APPLICABILITY

The described features as a whole make it possible to produce a press or a scrap shearing machine with increased efficiency, the technological flow of the material to be processed being improved overall.

The press according to the invention can also, for determining and/or monitoring the operating state and/or the volume of the hydraulic medium in the entire hydraulic system for functionally reliable and trouble-free operation, be equipped with what are known as dynamic control means (not illustrated here) which, via reference measurements on start-up of the press, control the hydraulic medium for subsequent operation and either cause the requisite operating state and/or the requisite volume of hydraulic medium in the hydraulic system, such as, for example, in the event of leaks, to be restored or ensure that the press shuts down in the event of deviations from the desired operating state of the hydraulic system.

1. A press for processing any type of material (3) comprising
a bed (1) which receives the material (3) and in which the material is compacted in a string-like fashion and fed for pressing and/or shearing with first hydraulic cylinders (1.3.1, 1.4.1, 1.5.1) for driving the compaction and feed steps;
a downstream column (2) with, guided therein and driven by a second hydraulic cylinder (2.2.2) fastened in a crosshead (2.1) of the column (2), at least one stamper (2.2) for further compaction and/or holding-down of the material (3) against a table (2.5);
at least one third hydraulic cylinder (2.4.2) for final processing of the material (3) against the table (2.5), and
a hydraulic control (5) with control block (7) and pipelines (6) for operating the hydraulic cylinders (1.3.1, 1.4.1, 1.5.1, 2.2.2, 2.4.2),
wherein:
a) the bed (1) is composed of a bottom (1.1) of a wall (1.2), a press plate (1.3) displaceable on the bottom (1.1) parallel to the wall (1.2), a lateral slide with a hydraulic cylinder (1.3.1), a press cover (1.4) mounted pivotably on the wall (1.2), at least one hydraulic cylinder (1.4.1), a feed plate (1.5) displaceable on the bottom (1.1) transversely to the direction of the press plate (1.3), a slide with an hydraulic cylinder (1.5.1), feet (1.8) and a filling hopper (1.9), the lateral slide with press plate (1.3) and the press cover (1.4) shaping in a functionally controlled sequence the cross section of the material (3) compacted in a string-like fashion, and the slide with feed plate (1.5) supplying the material (3) thus shaped to the column (2) for final processing such as pressing and/or shearing;
b) the column (2) is composed of the crosshead (2.1) connecting side parts (2.3) and the table (2.5) as a closed frame taking up the reaction forces arising and is designed for connection of the bed (1);
c) the hydraulic cylinders (1.3.1, 1.4.1, 1.5.1, 2.2.2, 2.4.2) with pistons have means (4) corresponding to reference points and/or quantities for measurement of the displacement, speed, acceleration and/or pressure of a kinematic state of at least one machine part, one operating state and/or the material (3) for an optimized and temporally coordinated operating sequence and/or processing operation of the material (3);
d) means (5.1) are provided in the hydraulic control (5), which, at least in one of the hydraulic cylinders (1.3.1, 1.4.1, 1.5.1, 2.2.2, 2.4.2) at the end of its working stroke, generate a damping pressure as for damping what is known as a cutting shock or end shock;
e) a torsion shaft (1.3.2) is mounted on or in the bed (1) and, by means of at least one mechanism, is connected in an articulated manner to the press plate (1.3) via a connecting-rod-like link (1.3.2.3) in such a way that the torsion shaft (1.3.2) with a lever (1.3.2.1) and the link (1.3.2.3), to prevent canting of the press plate (1.3) of the lateral slide, exerts a horizontal parallel thrust on the material (3) and at the same time a force component toward the bottom (1.1) of the bed (1) to prevent the press plate (1.3) lifting off, and
f) the press cover (1.4)
f1) has a power arm (1.4.2) which can be guided at least in part around the wall (1.2) and/or the bottom (1.1) and is connected to the hydraulic cylinder (1.4.1) which is articulated below the bottom (1.1);
f2) has a press arm (1.4.3) acting on the material (3), which is formed by the press cover (1.4) itself, the pivoting axis (1.2.1) of the press cover (1.4) running along an upper edge of the wall (1.2);
f3) is, with its power arm (1.4.2) and hydraulic cylinder (1.4.1) and also its press arm (1.4.3), designed in such a way in its particular position and exertion of the compaction acting vertically on the material (3) that the magnitude of the press arm (1.4.3) force, introduced with the pivoting movement, brings about the compaction of the material (3), starting with the angular position 0° of the press cover (1.4), related to the wall (1.2), increases as far as the angular position of roughly 40°-60°, the active force after an angular position of roughly 100° has been reached still being greater than the force acting on the material (3) at the beginning of pivoting, and accordingly exerts the force acting on the formation of the string of material (3) in any position>0° of the press cover (1.4) with a multiple of the force acting at 0°.

2. The press as claimed in claim 2, wherein the bed (1)
a) is divided subassembly-wise for alternative left or right embodiment, seen in a top view of the bed (1), with at least one technologically identical subassembly (1.6);
b) is lined with mutually constructionally identical wearing plates (1.7) which in their particular plurality correspond to the dimensions of at least one subassembly (1.6), and
c) has at least one wearing plate (1.7) with a means (1.7.1) for indicating the state of wear.

3. The press as claimed in claim 1, wherein the press cover (1.4) takes up a self-stabilizing end position in the fully open position owing to its mass.

4. The press as claimed in claim 1, wherein, in order to achieve a closed force flow, the at least one hydraulic cylinder (1.3.1) for the lateral slide (1.3) and the at least one hydraulic cylinder (1.4.1) for the press cover (1.4) are integrated spatially into the profile of the bed (1), the cross-sectional profile of the bed (1) has a ␣-shaped design, and the hydraulic cylinders (1.3.1, 1.4.1) lie in a plane.

5. The press as claimed in claim 1, wherein
a) the hydraulic cylinder (1.3.1) for the lateral slide (1.3) is supported in a bearing (1.3.2.2) on or in the bed (1), and
b) the hydraulic cylinder (1.4.1) for the press cover (1.4) is articulated in a bearing (1.10) on or the bed (1).

6. The press as claimed in claim 1, wherein the filling hopper (1.9) is arranged as a constructional unit above the bed (1) and
a) in the an open position the bed (1) receives the entire batch of the material (3) to be processed and
b) in a closed position the bed (1) holds prefilled material (3) ready for the subsequent position as at least a part batch of the material (3) to be processed.

7. The press as claimed in claim 1, wherein, according to the desired sequence of the lateral slide (1.3) and the press cover (1.4), in the advanced position of the lateral slide (1.3) and the pivoted-in position of the press cover (1.4), the material (3) is in the bed (1) precompacted to form a string of approximately rectangular and/or square cross section and prepared for feeding for further processing in the column (2).

8. The press as claimed in claim 1, wherein, for a scrap shearing machine,
a) a vertically movable carriage (2.4) for receiving a cutter (2.4.1) is guided in the column (2), which cutter works against a stationary cutter (2.5.1) in the table (2.5), said cutters (2.4.1, 2.5.1), seen in the feed direction of the material (3) prepressed in the bed (1) in a string-like fashion, separating the material after the further compaction and/or holding-down of the material (3) by the stamper (2.2), and
b) the carriage (2.4) is guided on each side part (2.3) of the column (2) between both an inner, stationary guide (2.3.1) and an outer, adjustable guide (2.3.2).

9. The press as claimed in claim 8, wherein, in order to achieve greater cutting lengths of the scrap shearing machine in the part stroke of the carriage (2.4) when the carriage (2.4) is not raised completely, the dimensioning of the stamper (2.2) in its depth (seen in the feed direction of the material (3)) is carried out in such a way that a greater feed motion of the material string can be selected and consequently greater cutting lengths are made possible and compression of the material (3) prepressed in a string-like fashion is also avoided.

10. The press as claimed in claim 1, wherein the stamper (2.2) is guided on a cross-member (2.2.1) which counteracts the forces which widen the [symbol] -frame shape of the column (2).

11. The press as claimed in claim 1, wherein at least one of the hydraulic cylinders (2.2.2, 2.4.2) is inserted, in a corresponding opening, from above in the crosshead (2.1) of the column (2), locked after radial rotation and fastened detachably.

12. The press as claimed in claim 1, wherein at least one of the hydraulic cylinders (1.3.1, 2.2.2, 2.4.2) is inserted and fastened detachably, in a corresponding opening, in its respective seat, such as from below in the crosshead (2.1) of the column (2), the fastening elements taking up the forces of the respective hydraulic cylinder (1.3.1, 2.2.2, 2.4.2) in the return stroke.

13. The press as claimed in claim 1, wherein the means (4) are means (4) which measure
without contact,
absolutely in any position,
optically,
magnetically and/or
by means of sound.

14. The press as claimed in claim 1, wherein an inclined plane surface designed as a chute (2.6) for gravity-dependent removal of the cut material (3) is arranged downstream of the column (2), which surface can be varied in its inclination depending on the stroke of the hydraulic cylinder (2.4.2) responsible for cutting the material (3).

15. The press as claimed in claim 1, wherein the cutters (2.4.1, 2.5.1) are fastened in their respective holders by means of a hydraulic cutter-clamping device (2.4.1.1, 2.5.2) in order to avoid play between the cutters (2.4.1, 2.5.1) and their holders.

16. The press as claimed in claim 1, wherein, in order to derive optimized operating sequences, values are detected via sensors (2.7) from properties of the material (3) as a reference variable for the press.

17. The press as claimed in claim 1, wherein the stamper (2.2) can be operated coupled to or uncoupled from the carriage (2.4).

18. The press as claimed in claim 1, wherein a bending stamp (2.4.3) acting on the material (3) before the cutter (2.4.1) is arranged on the carriage (2.4).

19. The press as claimed in claim 1, wherein, in order to achieve a high degree of preassembly and for the purpose of transport to the installation site, a preassembled first subassembly (6.1) of pipelines (6) is attached to a pair of the feet (1.8) on the bed (1).

20. The press as claimed in claim 19, wherein, in order to achieve a high degree of preassembly and for the purpose of transport to the installation site, a preassembled second subassembly (6.2) of pipelines (6) is attached to the column (2).

21. The press as claimed in claim 1, including a display for the operational management of the press and which indicates the respective operating state of at least one of the functions of the bed (1) and/or of the column (2).

22. The press as claimed in claim 21, wherein the display is used for the operational management of the press according to predefined sub-programs and also according to an optional combination thereof.

23. The press as claimed in claim 1, wherein further means are arranged in exposed locations on the hydraulic cylinders (1.3.1, 1.4.1, 1.5.1, 2.2.2, 2.4.2), which means determine the state of wear thereof on the basis of the pressure ratios.

24. The press as claimed in claim 1, wherein, for determining and/or monitoring the operating state and/or the volume of the hydraulic medium in the entire hydraulic system for functionally reliable or trouble-free operation of the press, dynamic control means are integrated, which, via reference measurements on start-up of the press, control the hydraulic medium for subsequent operation and either cause the requisite operating state and/or the requisite volume of hydraulic medium in the hydraulic system, such as in the event of leaks, to be restored or cause the press to shut down in the event of deviations from the desired operating state of the hydraulic system.
